(19) United States
(12) Patent Application Publication
(10) Pub. No.: US 2022/0350608 A1
(43) Pub. Date: Nov. 3, 2022

(54) BRANCH PREDICTION CIRCUIT AND INSTRUCTION PROCESSING METHOD

(71) Applicant: NEC Corporation, Minato-ku, Tokyo (JP)

(72) Inventor: Hiroki ASANO, Tokyo (JP)

(73) Assignee: NEC Corporation, Minato-ku, Tokyo (JP)

(21) Appl. No.: 17/761,293

(22) PCT Filed: Sep. 2, 2020
(86) PCT No.: PCT/JP2020/033283

§ 371 Date: Mar. 17, 2022

(30) Foreign Application Priority Data
Sep. 27, 2019 (JP) 2019-176937

(51) Int. Cl. G06F 9/38; G06F 9/30; G06F 9/345

(52) U.S. Cl. CPC G06F 9/3844; G06F 9/3005; G06F 9/345

(57) ABSTRACT

A branch prediction circuit includes a branch target address storage circuitry, a higher order address storage circuitry, an address generation circuitry, and a branch instruction execution circuitry. The branch target address storage circuitry stores a first address of a branch instruction executed in the past, a lower order address of a second address of an instruction to be executed next, and information pertaining to a reference target for a higher order address of the second address and to whether or not reference is needed. The higher order address storage circuitry stores the higher order address of the second address. The address generation circuitry generates the second address when a third address of an instruction to be newly executed matches the first address. The branch instruction execution circuitry provides an instruction for speculative execution of the instruction having the second address.

### TECHNICAL FIELD

The present invention relates to a branch prediction technique in pipeline processing of a processor.

### BACKGROUND ART

In a processor where performance is important, an instruction is executed by pipeline processing in order to increase a degree of parallelism of processing. When the instruction is executed, when there is a branch instruction, an instruction to be executed next is not determined until the branch instruction is resolved. Therefore, until the branch instruction is resolved, the pipeline may stop, and the performance may be degraded. In order to prevent this performance degradation and improve the performance, a method is adopted in which a branch prediction function is implemented to predict a result of the branch instruction and speculatively execute the next instruction.

When the branch result predicted by the branch prediction function is different from the execution result of the branch instruction, it is necessary to cancel all processes speculatively executed and start over. However, with sufficient prediction accuracy, the performance can be improved as a whole. The branch prediction is performed based on the execution result of the branch instruction executed in the past and held as a history. Therefore, in order to improve the prediction accuracy, it is desirable to store the execution result of the branch instruction, that is, the address of the instruction to be executed next to the branch instruction for more cases. However, in order to improve the prediction accuracy by such a method, an increase in the amount of hardware for holding the history of the branch prediction becomes a problem. Therefore, it is desirable to maintain the prediction accuracy while limiting the amount of required hardware. As such a technique of limiting the increase in the amount of hardware and maintaining the prediction accuracy, for example, a technique such as PTL 1 is disclosed.

PTL 1 relates to a branch prediction system in a processor that performs pipeline processing. The branch prediction system of PTL 1 holds the instruction address of the branch instruction executed in the past and the lower order address of the address of a branch prediction target in association with each other in a branch target buffer (BTB). When an address to fetch an instruction matches the instruction address of the branch instruction held in the BTB, the branch prediction system of PTL 1 performs branch prediction processing by joining the higher order address of the instruction address of the branch instruction and the lower order address of a branch target to generate the address of the branch prediction target. The branch prediction system of PTL 1 performs the branch prediction processing while suppressing the increase in the amount of hardware by holding only the lower order address of the branch target as described above.

### CITATION LIST

### Patent Literature

[PTL 1] JP 8-234980 A

### SUMMARY OF INVENTION

### Technical Problem

However, the technique of PTL 1 is not sufficient in the following points. In PTL 1, the higher order address of the instruction address of the branch instruction and the lower order address of the branch target held in the BTB are joined to generate the address of the branch prediction target. With such a configuration, in PTL 1, it is possible to maintain the prediction accuracy in a case where the branch prediction target is in an area where the instruction address and the higher order address of the branch instruction are the same, that is, in a case where the branch prediction target is in a short-distance location on a memory space, but it is not possible to predict the branch to a distant location. Therefore, in a case where an instruction arranged at a distant distance in the memory space is executed, such as a case where memory is secured dynamically, the branch prediction cannot be performed, and thus the processing speed may be reduced.

An object of the present invention is to provide a branch prediction circuit capable of performing branch prediction for a wide range of addresses while limiting the amount of required hardware and reductions in processing speed.

### Solution to Problem

In order to solve the above problem, a branch prediction circuit of the present invention includes a branch target address storage means, a higher order address storage means, an address generation means, and a branch instruction execution means. The branch target address storage means stores a first address of a branch instruction executed in past, a lower order address of a second address of an instruction to be executed next as an execution result of the branch instruction, information used to select a higher order address of the second address, and information indicating whether reference to the higher order address is necessary in association with each other. The higher order address storage means stores the higher order address of the second address. When a third address of an instruction to be newly executed matches the first address stored in the branch target address storage means, in a case where the reference to the higher order address is necessary, the address generation means reads the higher order address relevant to the information used to select the higher order address of the second address and generates the second address by joining the higher order address with the lower order address stored in the branch target address storage means. In a case where the reference to the higher order address is not necessary, the address generation means generates the second address by joining the higher order address of the third address with the lower order address stored in the branch target address storage means. The branch instruction execution means speculatively executes an instruction of the second address generated by the address generation means.

A branch prediction method of the present invention includes: storing a first address of a branch instruction executed in past, information used to select a higher order address of a second address of an instruction to be executed next as an execution result of the branch instruction, information indicating whether reference to the higher order address is necessary, and a lower order address of the second address in association with each other. The branch prediction method of the present invention includes: storing the higher order address of the second address. The branch prediction method of the present invention includes: reading, when a third address of an instruction to be newly executed matches the stored first address, the higher order address relevant to the information used to select the higher order address of the second address and generating the second address by joining the higher order address with the stored lower order address in a case where the reference to the higher order address is necessary. The branch prediction method of the present invention includes: generating the second address by joining the higher order address of the third address with the stored lower order address in a case where the reference to the higher order address is not necessary. The branch prediction method of the present invention includes: speculatively executing an instruction of the generated second address.

### Advantageous Effects of Invention

According to the present invention, the branch prediction for a wide range of addresses can be performed while limiting the amount of required hardware and reductions in processing speed.

### BRIEF DESCRIPTION OF DRAWINGS

FIG. 1 is a diagram illustrating an outline of a configuration of a first example embodiment of the present invention.

FIG. 2 is a diagram illustrating an outline of a configuration of a second example embodiment of the present invention.

FIG. 3 is a diagram schematically illustrating processing in an instruction fetch unit according to the second example embodiment of the present invention.

FIG. 4 is a diagram illustrating an example of a configuration of a higher order address table unit according to the second example embodiment of the present invention.

FIG. 5 is a diagram illustrating a configuration of a branch prediction control unit according to the second example embodiment of the present invention.

FIG. 6 is a diagram schematically illustrating hit determination processing in a branch prediction unit according to the second example embodiment of the present invention.

FIG. 7 is a diagram schematically illustrating processing of calculating a branch prediction target address according to the second example embodiment of the present invention.

FIG. 8 is a diagram schematically illustrating processing when determining a result of branch prediction according to the second example embodiment of the present invention.

FIG. 9 is a diagram schematically illustrating update processing of each data according to the second example embodiment of the present invention.

FIG. 10 is a diagram illustrating an example of an address in a configuration compared with the present invention.

### EXAMPLE EMBODIMENT

### First Example Embodiment

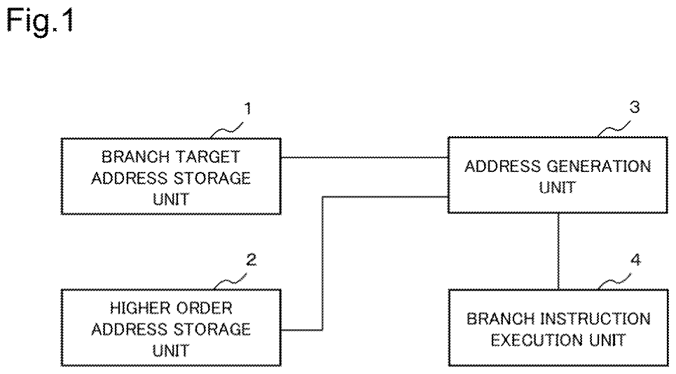

A first example embodiment of the present invention will be described in detail with reference to the drawings. FIG. 1 is a diagram illustrating an outline of a configuration of a branch prediction circuit according to the present example embodiment. The branch prediction circuit of the present example embodiment includes a branch target address storage unit 1, a higher order address storage unit 2, an address generation unit 3, and a branch instruction execution unit 4. The branch target address storage unit 1 stores a first address of a branch instruction executed in the past, a lower order address of a second address of an instruction to be executed next as an execution result of the branch instruction, information used to select a higher order address of the second address, and information indicating whether reference of the higher order address is necessary in association with each other. The higher order address storage unit 2 stores the higher order address of the second address. When a third address of the instruction to be newly to executed matches the first address stored in the branch target address storage unit 1, the address generation unit 3 reads the higher order address relevant to the information used to select the higher order address of the second address in a case where reference to the higher order address is necessary, and generates the second address by joining the higher order address with the lower order address stored in the branch target address storage unit 1. The address generation unit 3 generates the second address by joining the higher order address of the third address and the lower order address stored in the branch target address storage unit 1 in a case where the reference to the higher order address is not made. The branch instruction execution unit 4 speculatively executes the instruction of the second address generated by the address generation unit 3.

The branch prediction circuit of the present example embodiment divides an address at the time of performing branch prediction into a higher order address and a lower order address and holds the higher order address and the lower order address, and combines the addresses at the time of executing a branch instruction to generate the address of an execution target. Since the branch prediction circuit of the present example embodiment can store the higher order address as common information, it is possible to limit the amount of hardware required to store the address. Since the address of the branch target is generated based on the information indicating whether reference of the higher order address is necessary, data on the higher order address table is not required in the case of prediction of a short distance on an address space. Therefore, it is possible to perform prediction processing in both the case of prediction of a short distance on the address space and the case of predicting a branch to a distant address while limiting reductions in processing speed by suppressing a frequency of updating the higher order address table. As a result, the branch prediction circuit of the present example embodiment can perform branch prediction for a wide range of addresses while limiting the amount of required hardware and reductions in processing speed.

### Second Example Embodiment

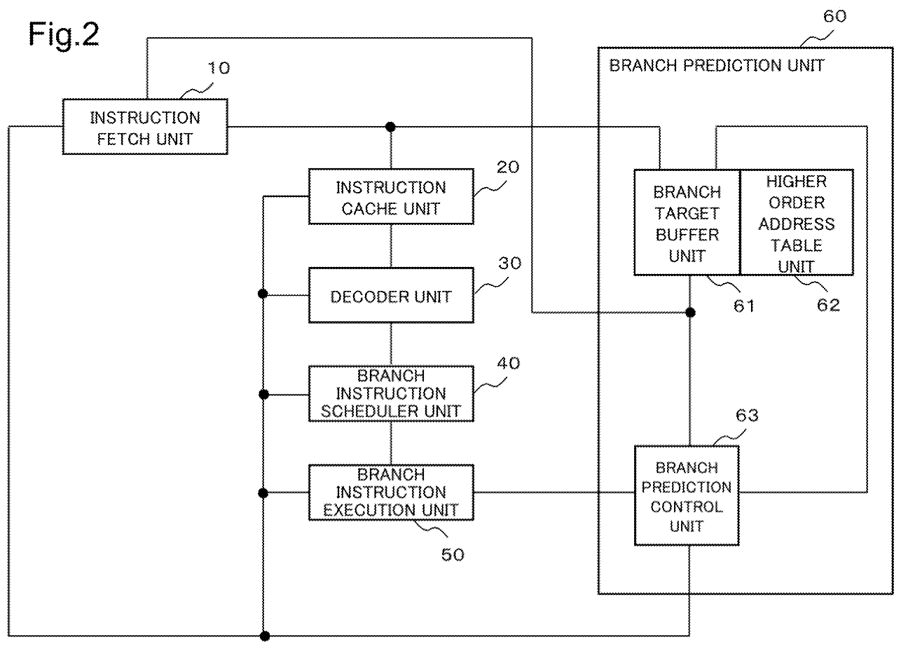

A second example embodiment of the present invention will be described in detail with reference to the drawings. FIG. 2 is a block diagram illustrating a configuration of a branch prediction circuit according to the present example embodiment. The branch prediction circuit of the present example embodiment includes an instruction fetch unit 10, an instruction cache unit 20, a decoder unit 30, a branch instruction scheduler unit 40, a branch instruction execution unit 50, and a branch prediction unit 60.

The branch prediction circuit of the present example embodiment is a circuit that is implemented in a processor having a pipeline processing function and performs processing related to branch prediction. In the following description, a case where the branch prediction circuit of the present example embodiment is implemented in a processor that executes an instruction arranged with 8 bytes in a 64-bit address space will be described as an example. The instruction processed by the branch prediction circuit and the processor of an implementation target of the present example embodiment may be an expression other than 8 bytes, and the address space may be set other than 64 bits.

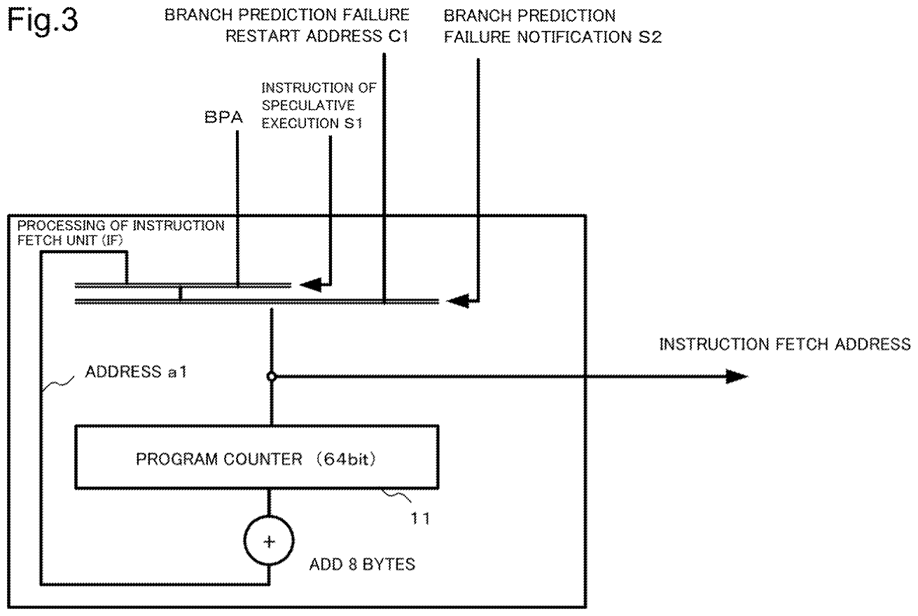

The configuration of the instruction fetch unit 10 will be described. FIG. 3 is a diagram schematically illustrating processing of an instruction in the instruction fetch unit 10. The instruction fetch unit 10 has an instruction fetch function. The instruction fetch unit 10 selects an address of an instruction to be executed next, and outputs the selected address to the instruction cache unit 20 and the branch prediction unit 60. The instruction fetch unit 10 further includes a program counter 11. The program counter 11 stores an address of an instruction requested to be executed by a computer program.

The instruction fetch unit 10 selects an address to fetch an instruction, that is, an address of an instruction to execute processing from one of three classifications of addresses. The first of the three classifications is an address selected in a case where the instruction progresses sequentially. In a case where the instruction progresses sequentially, an address a1 obtained by counting up the value of the program counter 11 by 8 bytes which is the instruction length of one instruction is selected. The second of the three classifications is a prediction target address (BPA: branch prediction address) selected in a case where an instruction S1 of speculative execution is received from the branch prediction unit 60. The third of the three classifications is a branch prediction failure restart address c1 selected in a case where a branch prediction failure notification S2 is received from the branch prediction unit 60. The instruction fetch unit 10 outputs the selected address as an instruction fetch address to the instruction cache unit 20 and a branch target buffer unit 61. The instruction fetch unit 10 updates the program counter 11 when outputting the selected instruction address.

The instruction cache unit 20 is a cache memory that temporarily stores an instruction read from a memory. When data relevant to the instruction address input from the instruction fetch unit 10 exists in a cache, the instruction cache unit 20 outputs the held instruction data to the decoder unit 30 together with the instruction address. When the data relevant to the instruction address input from the instruction fetch unit 10 does not exist in the cache, the instruction cache unit 20 reads the target data from the memory, holds the target data in the cache, and outputs the target data to the decoder unit 30.

The decoder unit 30 analyzes the instruction data input from the instruction cache unit 20, classifies the instruction data according to the specification of the instruction set included in the processor, and registers the instruction data and the address in an instruction scheduler (reservation station). When the instruction data indicates a branch instruction, the decoder unit 30 registers the instruction data and the instruction address in the branch instruction scheduler unit 40.

The branch instruction scheduler unit 40 is an instruction scheduler (reservation station) of a branch instruction that waits for execution. The branch instruction scheduler unit 40 is also referred to as a branch reservation station (BRS). The branch instruction scheduler unit 40 checks the availability of the branch instruction execution unit 50 and outputs the instruction data to the branch instruction execution unit 50 at an executable timing.

The branch instruction execution unit 50 executes a branch instruction. The branch instruction execution unit 50 is also referred to as a branch execution pipe (BEP). The branch instruction execution unit 50 executes a branch instruction and determines whether to branch or not to branch (hereinafter, referred to as “taken/ntaken”). The branch instruction execution unit 50 executes a branch instruction, and calculates an instruction address (Target Address: TA) when calculating the result of taken/ntaken. The branch instruction execution unit 50 outputs information of taken/ntaken and the instruction address to the branch prediction control unit 63.

The branch prediction unit 60 has a function of controlling processing related to branch prediction and determining the result of the branch prediction. The branch prediction unit 60 further includes the branch target buffer unit 61, a higher order address table unit 62, and the branch prediction control unit 63.

The branch target buffer unit 61 stores an instruction address of a branch instruction executed in the past and a lower target address (LTA) which is a lower order address of an instruction address of an instruction to be executed next to a branch instruction, that is, a branch prediction target obtained as a result of executing the branch instruction in association with each other. The branch target buffer unit 61 is also referred to as a branch target buffer (BTB). The branch target buffer unit 61 stores data obtained by further adding information indicating a reference target of a higher order address as an upper target address table pointer (UP) to the instruction address of the branch instruction executed in the past and the LTA. The UP is information indicating a storage position on an upper target address table (UTAT) of a higher order address relevant to the LTA. When the UP is 0, it is set to indicate that the instruction address of the branch instruction executed in the past is the same as the higher order address of the branch prediction target. That is, in a case where the UP is 0, branch prediction of a short distance in which an instruction address to be newly input is close to the higher order address of the branch prediction target is performed on the memory space.

The branch target buffer unit 61 stores, for example, 1024 entries of data in which the instruction address of the branch instruction executed in the past, the LTA, and the UP are associated with each other. Each entry is also referred to as a BTB entry. The branch target buffer unit 61 can also be referred to as a branch target address storage unit.

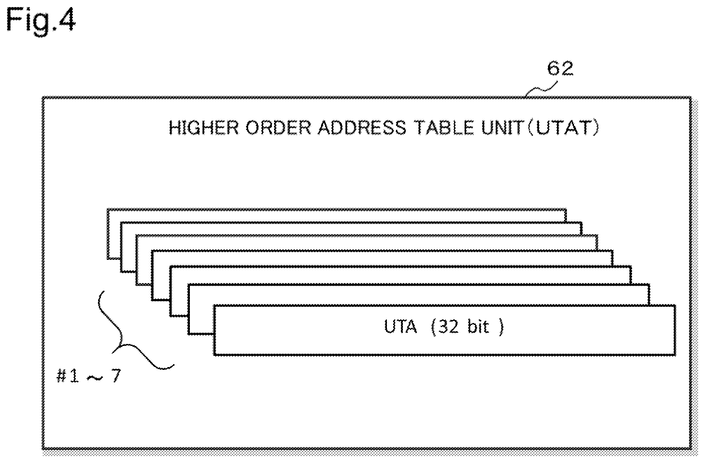

The higher order address table unit 62 stores, as the UTAT, a data table storing an upper target address (UTA) that is a higher order address of the instruction address of the branch prediction target. FIG. 4 is a diagram illustrating an example of the configuration of the UTAT of the higher order address table unit 62. In the example of FIG. 4, seven 32-bit UTAS are stored in the UTAT. The higher order address table unit 62 can also be referred to as a higher order address storage unit.

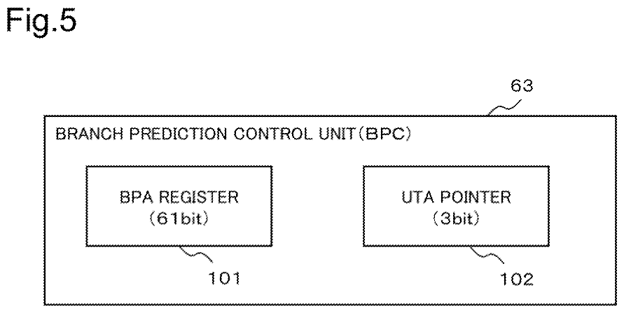

The branch prediction control unit 63 has a function of generating an address of a branch target and a function of determining whether a branch prediction result matches an actual processing result. The branch prediction control unit 63 is also referred to as branch prediction control (BPC). As illustrated in FIG. 5, the branch prediction control unit 63 further includes a BPA register 101 and a UTA pointer 102. The BPA register 101 temporarily holds an address of an instruction that is performing speculative execution at the time of branch prediction. The UTA pointer 102 holds information of a write target of the UTA. In the example of FIG. 5, the BPA register is set to be able to store 61-bit data, and the UTA pointer is set to be able to store 3-bit data. The branch prediction control unit 63 can also be referred to as an address generation unit.

The operation of the branch prediction circuit of the present example embodiment will be described. First, an operation when branch prediction is performed will be described. The instruction cache unit 20 reads an address of an instruction to be executed next from the program counter 11 and outputs the read address as an instruction address to the instruction cache unit 20 and the branch prediction unit 60.

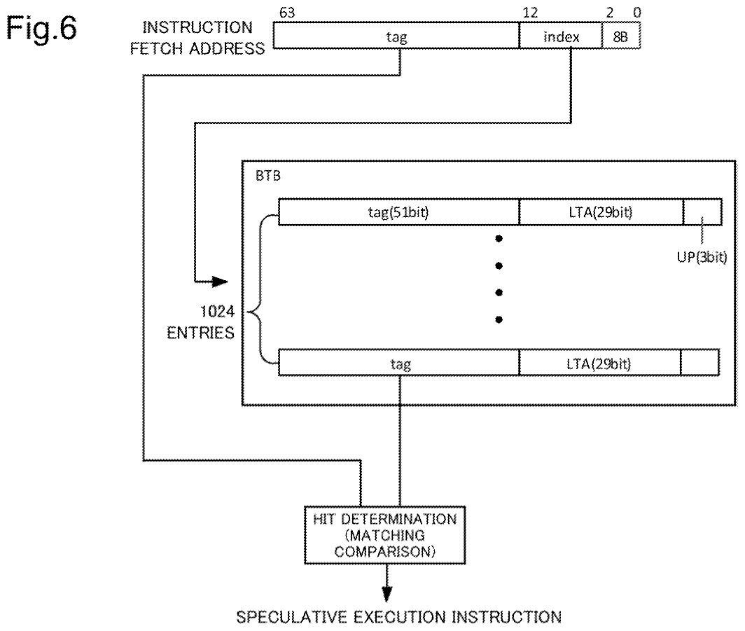

When an instruction fetch address is input from the instruction fetch unit 10, the branch prediction unit 60 reads the relevant BTB entry from the branch target buffer unit 61 and performs hit determination. FIG. 6 is a diagram schematically illustrating hit determination processing in the branch prediction unit 60. In FIG. 6, the instruction address of the branch instruction executed in the past is illustrated as tag on the BTB. The branch target buffer unit 61 reads a relevant entry using a portion of [12:0] in the instruction fetch address [63:3] as illustrated in FIG. 6 as an index.

For example, if [12:3] is 7, the branch prediction unit 60 reads the seventh entry of the BTB. After reading the BTB entry, the branch prediction unit 60 compares the tag of the instruction fetch address that is the newly input instruction address with the information of the tag of the read BTB entry, and performs hit determination.

When the instruction fetch address matches the information of the tag of the read BTB entry, the branch prediction unit 60 determines a hit. When the hit is determined, the branch prediction unit 60 sends the result of the hit determination as a speculative execution instruction to the instruction fetch unit 10 and the branch prediction control unit 63.

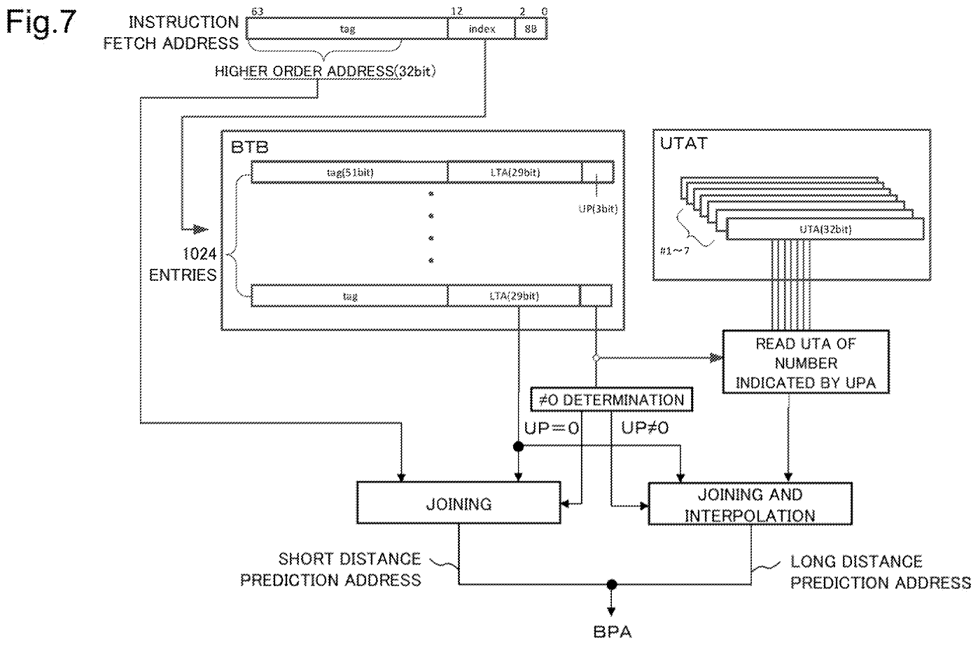

When the hit is determined, the branch prediction unit 60 refers to the UP of the BTB entry and generates a BPA which is the address of the branch prediction target. FIG. 7 is a diagram schematically illustrating processing of calculating the address of the branch prediction target. When UP is 0, as the branch prediction of the short distance in which the higher order address does not change, the branch prediction unit 60 joins the higher order 32 bits of the instruction fetch address and the read LTA to generate a BPA which is a short distance prediction address.

When the UP is other than 0, the branch prediction unit 60 reads the UTA from the entry of the UTAT indicated by the UP and joins the UTA with the LTA. For example, when the UP is 3, the branch prediction unit 60 joins the UTA stored in the third entry of the UTAT and the LTA. The branch prediction unit 60 interpolates 0 to the lowest order 3 bits which is an instruction address array with respect to the address obtained by joining the UTA and the LTA, and sets the interpolated address as a BPA which is a long distance prediction address.

When the BPA is generated, the branch prediction unit 60 outputs the result of the hit determination and the BPA to the instruction fetch unit 10 and the branch prediction control unit 63. When the result of the hit determination and the BPA are input, the branch prediction control unit 63 stores the input BPA in the branch target register.

When the BPA is input, the instruction fetch unit 10 sends the address indicated in the BPA as an instruction address to the instruction cache unit 20 to start speculative execution.

Next, branch processing and determination of the branch prediction result will be described. When the instruction fetch unit 10 outputs the instruction address to the instruction cache unit 20 and the branch prediction unit 60, and the instruction address is input to the instruction cache unit 20, the instruction cache unit 20 checks whether the input instruction address exists in the cache.

When the data relevant to the input instruction address is not in the cache, the instruction cache unit 20 reads the data relevant to the instruction address from the memory and stores the data in the cache memory. The instruction cache unit 20 outputs the instruction address and the data read from the memory to the decoder unit 30.

When the data relevant to the input instruction address is stored in the cache, the instruction cache unit 20 outputs the data relevant to the instruction address as instruction data to the decoder unit 30 together with the instruction address.

When the instruction data and the instruction address are input, the decoder unit 30 analyzes the input instruction data. The decoder unit 30 classifies the instruction data based on the specification of the instruction set, and registers the instruction data and the instruction address in the instruction scheduler. When the instruction data is a branch instruction, the decoder unit 30 registers the instruction data and the instruction address in the branch instruction scheduler unit 40.

When the instruction data and the instruction address are registered, the branch instruction scheduler unit 40 checks the availability of the instruction processing of the branch instruction execution unit 50 and outputs the instruction data to the branch instruction execution unit 50 at an executable timing.

When the instruction data is input, the branch instruction execution unit 50 executes the branch instruction to determine taken/ntaken, and calculate an instruction address. The branch instruction execution unit 50 outputs the execution result of the branch instruction, that is, the determination result of taken/ntaken and the information of the instruction address to be executed next to the branch prediction control unit 63 of the branch prediction unit 60.

When the execution result of the branch instruction is taken, the branch prediction control unit 63 determines that the instruction address is an address to fetch an instruction next. When the execution result of the branch instruction is ntaken, the branch prediction control unit 63 determines that the address obtained by adding 8 bytes to the instruction address is the address to fetch an instruction next.

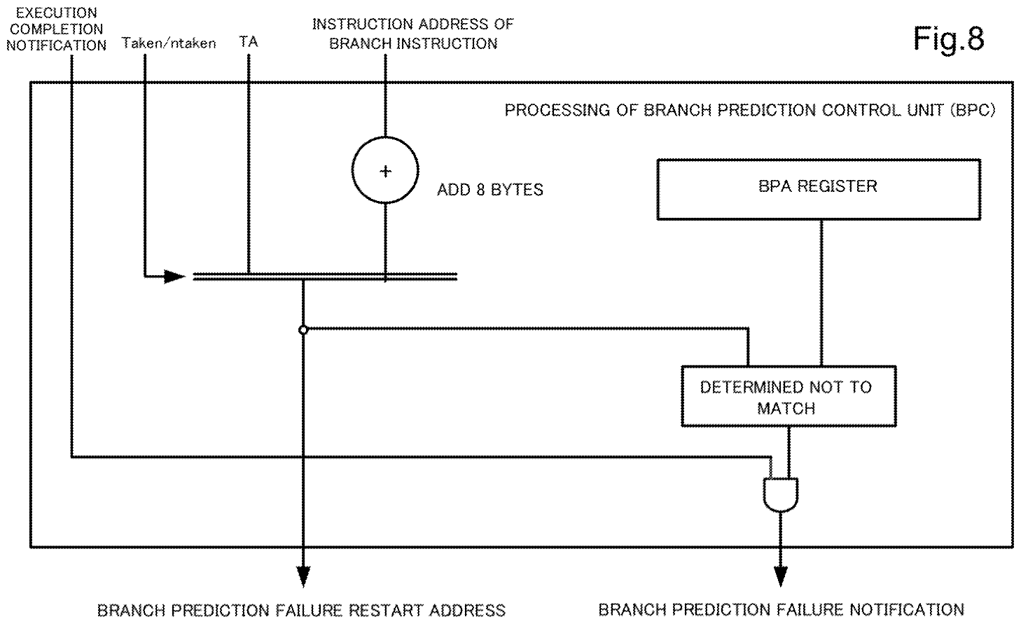

When the address to fetch an instruction next is determined, the branch prediction control unit 63 compares the address to fetch an instruction next with the BPA stored in the BPA register. FIG. 8 is a diagram schematically illustrating processing when determining the result of the branch prediction.

Next, a case where the address determined to fetch an instruction next does not match the BPA stored in the BPA register will be described. FIG. 8 is a diagram illustrating processing in a case where the address determined to fetch an instruction does not match the BPA. The branch prediction control unit 63 compares the address of the branch instruction with the BPA, and determines that the branch prediction has failed when the address determined to fetch an instruction does not match the BPA. When determining that the branch prediction has failed, the branch prediction control unit 63 notifies the instruction fetch unit 10 of a branch prediction failure notification and a branch prediction failure restart address. The branch prediction control unit 63 outputs the branch prediction failure notification to the instruction cache unit 20, the decoder unit 30, the branch instruction scheduler unit 40, and the branch instruction execution unit 50. When the branch prediction failure notification is input, the instruction cache unit 20, the decoder unit 30, the branch instruction scheduler unit 40, and the branch instruction execution unit 50 discard the processing during the speculative execution.

When the execution result of taken is input, the branch prediction control unit 63 compares the higher order address of the instruction address of the branch instruction with the UTA. When the higher order address of the instruction address of the branch instruction does not match the UTA, the branch prediction control unit 63 sends a request for updating the UTA to the higher order address table unit 62 and updates the UTAT.

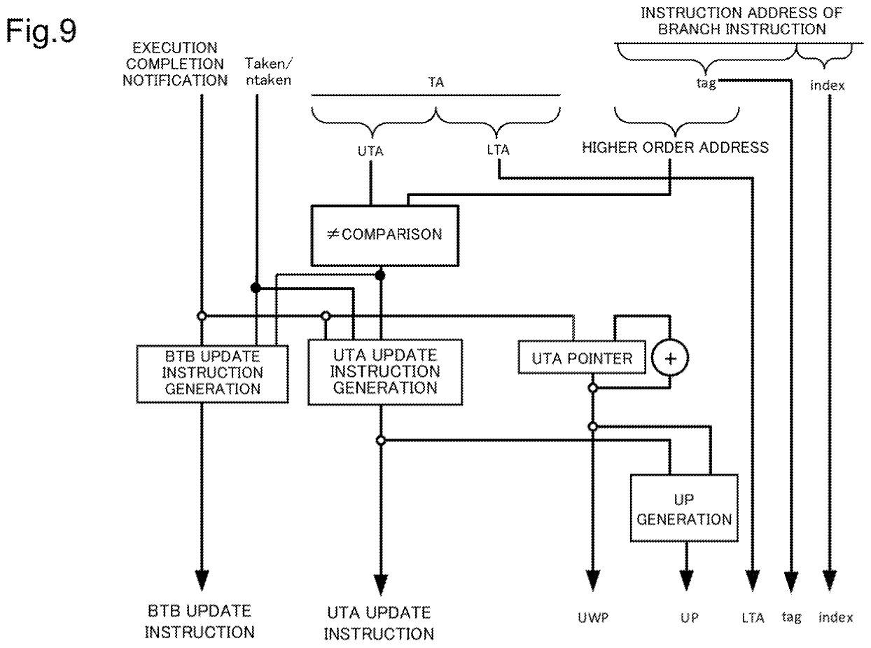

FIG. 9 is a diagram schematically illustrating update processing of the UTAT and the BTB in the branch prediction control unit 63. First, the update processing of the UTAT in the processing illustrated in FIG. 9 will be described. When the execution of the branch instruction is completed, an execution completion notification, taken/ntaken, a TA, and the instruction address of the branch instruction are input from the branch instruction execution unit 50 to the branch prediction control unit 63. When the execution of the branch instruction is completed, the branch prediction control unit 63 compares the UTA included in the TA with the higher order address of the instruction address of the branch instruction. In the branch prediction control unit 63, when the notification of the completion of the instruction execution and the execution result of taken are input, the branch prediction control unit 63 generates the UTA update instruction when the higher order address of the instruction address of the branch instruction does not match the comparison result of the UTA. The UTA data is added to the UTA update instruction. The branch prediction control unit 63 sends the generated UTA update instruction to the higher order address table unit 62. When the execution completion notification of the branch instruction is input, the UTA pointer sends a value UWP of the UTA pointer to the higher order address table unit 62 and performs counting-up. When the UTA update instruction is generated, the branch prediction control unit 63 generates a value of the UP. As the value of the UP, the value of the UTA pointer is used when the update instruction of the UTAT is sent. In a case where the update instruction of the UTAT is not sent, the value of the UP is 0.

When the UTA update instruction and the UWP are input, the higher order address table unit 62 updates the data of the UTA of the entry designated by the UWP.

The update processing of the BTB in the processing illustrated in FIG. 9 will be described. When the update of the UTA is requested, that is, when the notification of the completion of the execution of the branch instruction and the execution result of taken are input, the branch prediction control unit 63 generates the BTB update instruction to request the update of the BTB when the higher order address of the instruction address of the branch instruction does not match the comparison result of the UTA. When the BTB update instruction is generated, the branch prediction control unit 63 sends the BTB update instruction to the branch target buffer unit 61. When sending the BTB update instruction, the branch prediction control unit 63 sends the generated value of the UP to the branch target buffer unit 61.

When the BTB update instruction and the UP are input, the branch target buffer unit 61 updates the tag of the entry relevant to the index of the instruction address of the branch instruction, the LTA, and the value of the UP. The tag, the index, and the like correspond to the values illustrated in FIG. 6.

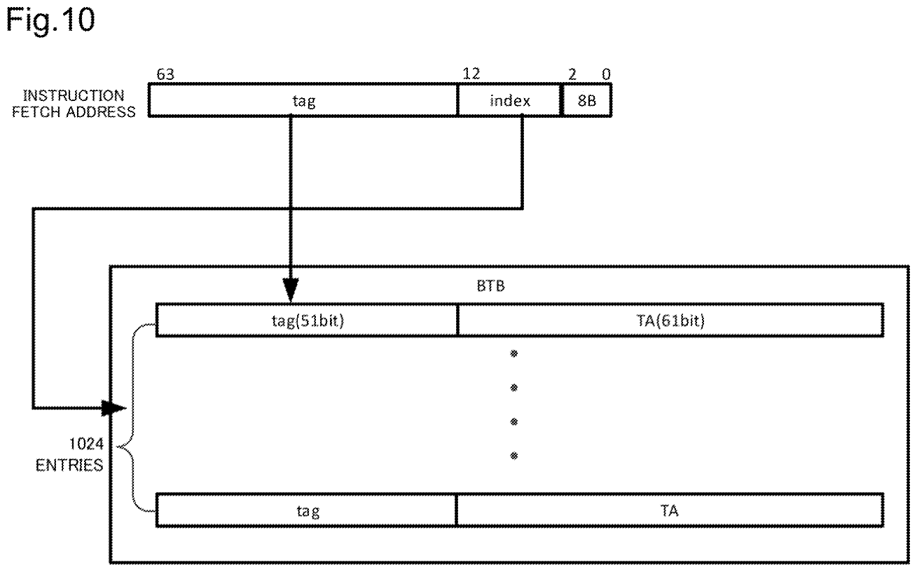

FIG. 10 schematically illustrates a data configuration in a case where the instruction address of the branch target is held without being divided, as an example in comparison with the present example embodiment. As illustrated in FIG. 10, in a case where the data amount per instruction address is held as it is without being divided into 112-bit addresses, the data amount of 1024 entries is about 14000 bytes. On the other hand, in the present example embodiment, the BTB (FIG. 6) of 83 bits per address is about 10,000 bytes for 1024 entries, and the UTAT (FIG. 4) is 28 bytes for seven 32-bit entries. Thus, it is possible to reduce the capacity required for storing the address of the branch prediction target.

In the present example embodiment, a case where seven entries of UTA are held in the UTA table has been described, but the number of entries may be other than seven. In order to improve the prediction accuracy, the branch prediction method may be combined with another branch prediction method. In the present example embodiment, a case where the LTA is 29 bits has been described as an example, but in a processor that executes a program having high locality of instruction arrangement, the bit width of the UTA may be set longer, and the LTA may be set shorter than in the present example embodiment. With such a configuration, it is possible to further limit the hardware amount.

The branch prediction circuit of the present example embodiment stores, in the UTAT table, the UTA that is the higher order address of the branch target address (BPA) that is the instruction address of the branch prediction target. The branch prediction circuit of the present example embodiment holds, as the BTB, information obtained by combining the instruction address of the branch instruction executed in the past, the LTA of the address of the branch prediction target, and the UP indicating the storage target of the UTA of the address of the branch prediction target on the UTAT. Since the address arrangement of instructions often has locality, the UTA is likely to require a small number of entries relative to the BTB. Therefore, the branch prediction circuit of the present example embodiment can limit the amount of data required for each BTB entry by storing the higher order address of the address of the branch prediction target as the UTAT, and thus, it is possible to limit the amount of hardware required for branch prediction.

The branch prediction circuit of the present example embodiment refers to the UP when generating the BPA which is the address of the branch prediction target, and generates the BPA by joining the UTA of the relevant UTAT and the LTA of the BTB when the UP is other than 0. As described above, a case where the UP is other than 0 corresponds to the branch prediction to a distant address on the memory address space.

A case where the UP is 0 corresponds to the branch prediction of a short distance on the memory address space, and the branch prediction circuit determines that the higher order address of the branch target address is the same as the higher order address of the instruction address. In a case where the UP is 0, the branch prediction circuit sets the higher order address of the instruction address as the UTA, and generates the BPA by joining the higher order address of the instruction address with the LTA of the BTB. As described above, the branch prediction circuit of the present example embodiment can perform the branch prediction to a short distance address and the branch prediction to a distant address on the address space. As described above, the branch prediction circuit of the present example embodiment can perform branch prediction for a wide range of addresses while limiting the amount of required hardware and reductions in processing speed.

The present invention has been described above using the above-described example embodiments as examples. However, the present invention is not limited to the above-described example embodiments. That is, the present invention can apply various aspects that can be understood by those skilled in the art within the scope of the present invention.

This application is based upon and claims the benefit of priority from Japanese patent application No. 2019-176937, filed on Sep. 27, 2019, the disclosure of which is incorporated herein in its entirety by reference.

### REFERENCE SIGNS LIST

1 branch target address storage unit
2 higher order address storage unit
3 address generation unit
4 branch instruction execution unit
10 instruction fetch unit
11 program counter
20 instruction cache unit
30 decoder unit
40 branch instruction scheduler unit
50 branch instruction execution unit
60 branch prediction unit
61 branch target buffer unit
62 higher order address table unit
63 branch prediction control unit
101 BPA register
102 UTA pointer

What is claimed is:

1. A branch prediction circuit comprising:
a branch target address storage circuitry configured to store a first address of a branch instruction executed in past, a lower order address of a second address of an instruction to be executed next as an execution result of the branch instruction, information used to select a higher order address of the second address, and information indicating whether reference to the higher order address is necessary in association with each other;
a higher order address storage circuitry configured to store the higher order address of the second address;
an address generation circuitry configured to, when a third address of an instruction to be newly executed matches the first address stored in the branch target address storage circuitry, read the higher order address relevant to the information used to select the higher order address of the second address and generate the second address by joining the higher order address with the lower order address stored in the branch target address storage circuitry in a case where the reference to the higher order address is necessary, and generate the second address by joining the higher order address of the third address with the lower order address stored in the branch target address storage circuitry in a case where the reference to the higher order address is not necessary; and
a branch instruction execution circuitry configured to speculatively execute an instruction of the second address generated by the address generation circuitry.

2. The branch prediction circuit according to claim 1, wherein
the higher order address storage circuitry stores the higher order address of the second address as an address table, and
the information used to select the higher order address of the second address is information indicating an order on the address table.

3. The branch prediction circuit according to claim 2, wherein when the information used to select the higher order address of the second address is a predetermined number, it is set to indicate that the reference to the higher order address is necessary.

4. The branch prediction circuit according to claim 1, wherein
the branch instruction execution circuitry compares a fourth address of an instruction to be executed next to the instruction of the third address obtained as an execution result of the instruction of the third address with the second address, and updates data of the second address in the branch target address storage circuitry and the higher order address storage circuitry with data of the fourth address when the fourth address does not match the second address.

5. The branch prediction circuit according to claim 1, wherein
the branch instruction execution circuitry compares the fourth address of the instruction to be executed next to the instruction of the third address obtained as the execution result of the instruction of the third address with the second address, and discards the speculative execution of the instruction of the second address when the fourth address does not match the second address.

6. A processor comprising:
the branch prediction circuit according to claim 1;
an instruction fetch circuitry configured to output an address of an instruction to be executed as an instruction address; and
an instruction execution circuitry configured to execute the instruction of the address output by the instruction fetch circuitry, wherein
the branch prediction circuit uses the address output by the instruction fetch circuitry as the third address, and
when the branch prediction circuit outputs the second address, the instruction fetch circuitry outputs the second address as the instruction address.

7. A branch prediction method comprising:
storing a first address of a branch instruction executed in past, information used to select a higher order address of a second address of an instruction to be executed next as an execution result of the branch instruction, information indicating whether reference to the higher order address is necessary, and a lower order address of the second address in association with each other;
storing the higher order address of the second address;
when a third address of an instruction to be newly executed matches the stored first address, reading the higher order address relevant to the information used to select the higher order address of the second address and generating the second address by joining the higher order address with the stored lower order address in a case where the reference to the higher order address is necessary, and generating the second address by joining the higher order address of the third address with the stored lower order address in a case where the reference to the higher order address is not necessary; and
speculatively executing an instruction of the generated second address.

8. The branch prediction method according to claim 7, wherein
the method further comprises:
storing the higher order address of the second address as an address table, wherein
the information used to select the higher order address of the second address is information indicating an order on the address table.

9. The branch prediction method according to claim 8, wherein
the reference to the higher order address indicates necessary, when the information used to select the higher order address of the second address is a predetermined number.

10. The branch prediction method according to claim 7, wherein
the method further comprises:
comparing a fourth address with the second address, wherein the fourth address is an address of instruction to be executed next to the instruction of the third address obtained as an execution result of the instruction of the third, and
when the fourth address does not match the second address,
updating data of the stored second address by using data of the fourth address.
